(19) United States
(12) Patent Application Publication
(10) Pub. No.: US 2008/0005223 A1
(43) Pub. Date: Jan. 3, 2008

(54) REPUTATION DATA FOR ENTITIES AND DATA PROCESSING

(75) Inventors: Gary W. Flake, Bellevue, WA (US); Eric J. Horvitz, Kirkland, WA (US); John C. Platt, Bellevue, WA (US); Joshua T. Goodman, Redmond, WA (US); William H. Gates, Medina, WA (US); Alexander G. Gounares, Kirkland, WA (US); Kenneth A. Moss, Mercer Island, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/427,315

(22) Filed: Jun. 28, 2006

(51) Int. Cl. G06F 15/173; G06F 15/18

(52) U.S. Cl. 709/203; 706/12

(57) ABSTRACT

Architecture for creation and processing of reputation data for entities such as websites, users, hardware, software, documents, objects and facts. Reputation data can be utilized in connection with web-based searching such that the reputation of websites provides a metric in connection with ranking of search results as well as enhancing delivery of meaningful and accurate information to users. A computer-implemented system is provided that comprises an aggregation component for receiving and aggregating information relating to an entity (e.g., user, website, data, hardware, software), and a reputation engine that employs the aggregated information to generate reputation data therefrom. Other aspects allow for management of the data, hardware and software based on the reputation data, and access to such entities.

### BACKGROUND

The proliferation of data and information on network entities such as Internet websites is rapidly increasing. Users can intentionally access all kinds and types of information. While this can be a significant benefit in terms of finding desired information, the sheer amount of available information begins to impede the speed at which the desired information can be found. Search engines are continually being developed to more efficiently and effectively search and sort through millions of web documents for the desired search results. However, a listing of thousands to millions of pages of information can still be a daunting, if not impossible, task to review.

Similarly, not only has information searching and retrieval become a formidable challenge, but finding users and/or systems of like characteristics or attributes among the millions of Internet users and systems can be difficult. Social contexts such as chat rooms can provide a means for communicating between users; however, in such contexts, means for controlling access and sharing information are oftentimes inadequate since users are unknown, and consequently, the sharing of information is limited to a high level. In at least both instances mentioned above, users and systems need ways in which the exchange of information or membership to a group can be validated independent of user or system interrogation by other entities.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates creation of reputation data for entities such as websites, users, hardware, software, documents, objects and facts. This can be performed in connection with web-based searching, for example. In a more specific example, the reputation of websites can be an important metric in connection with ranking of search results as well as enhancing delivery of meaningful and accurate information to users.

In accordance therewith, disclosed and claimed herein, in one aspect thereof, is a computer-implemented system that facilitates network-based interaction. The system comprises an aggregation component that receives and aggregates information relating to an entity, and a reputation engine that employs the aggregated information to generate reputation rank data for the entity. The reputation rank can then be employed in connection with web-based searching.

The reputation engine analyzes information, and in the context of a website information such as click-through rate, user feedback, and other extrinsic evidence in connection with determining the reputation of websites, web pages, blogs, entities, etc., for example. Another aspect facilitates determining reputation as a function of a vector-based analysis where the number of references to a site are determined and considered in connection with rating the reputation of the site. In yet another aspect, reputation data of individuals and/or groups can be validated, for example, in relation to on-line social networks, dating, referral services, restaurants, vendors, etc.

In accordance with particular embodiments, an authenticity enabler can be employed for 3^{rd} parties to provide users with a measure of certainty about their site meeting a pre-determined standard of quality, a peer-to-peer version provides for clustering/introducing individuals of like reputation and quality of services so that they can leverage off of joint efforts with respect to a variety of efforts (e.g., group projects, file sharing, coordinated searching/research, news reporting, . . . ), credibility/security ratings can be developed for individuals and/or sites which can facilitate individuals with high credibility undergoing lesser scrutiny per Internet-based transaction in view of his/her credentials and, advertising and economic models can also be based in part of reputation rankings.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates network-based interaction utilizing reputation data in accordance with an innovative aspect.

FIG. 2 illustrates a methodology that facilitates network-based interaction through utilization of reputation data.

FIG. 3 illustrates a reputation system that employs a validation component for reputation validation in accordance with another aspect.

FIG. 4 illustrates a methodology of reputation validation for search processing in accordance with another aspect of the innovation.

FIG. 5 illustrates a methodology of factoring in reference data of a website as part of the generation of reputation data.

FIG. 6 illustrates a methodology of reputation analysis based on users in accordance with the disclosed innovation.

FIG. 7 illustrates a methodology of reputation analysis and generation for a purpose of website certification in accordance with another aspect.

FIG. 8 illustrates a flow diagram of a methodology of developing and utilizing credibility/security rating data in accordance with an innovative aspect.

FIG. 9 illustrates a flow diagram of a methodology for employing reputation data in advertising and/or economic models.

FIG. 10 illustrates a methodology of peer network processing of reputation information in accordance with an aspect of the innovation.

FIG. 11 illustrates a flow diagram of a methodology of managing access based on reputation data.

FIG. 12 illustrates a methodology of processing metadata based on reputation information.

FIG. 13 illustrates a flow diagram that represents a methodology of managing application installation and operation based in part on reputation data in accordance with a novel aspect.

FIG. 14 illustrates a flow diagram that represents a methodology of managing document publication based in part on reputation data.

FIG. 15 illustrates a methodology of managing central data and information repositories by utilizing reputation data.

FIG. 16 illustrates a system that employs a machine learning and reasoning component which facilitates automating one or more features in accordance with the subject innovation.

FIG. 17 illustrates a block diagram of a computer operable to facilitate development, analysis and processing of reputation data, and execution of other aspects of the disclosed architecture.

FIG. 18 illustrates a schematic block diagram of an exemplary computing environment operable for processing reputation data in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Generally, the disclosed innovation facilitates the generation of reputation data which can thereafter be utilized to perform or affect a number of functions. For example, reputation information related to a website, for example, can be employed to manage search results associated with that website. Reputation in this context is related to the general opinion, or developed attributes, characteristics or properties about a network entity (e.g., website, user) as developed by other network entities. In one example, the reputation of a website (a network entity) is developed by subjective user feedback associated with many users (other network entities) accessing (or failing to gain access to) information of the website. Surveys and forum feedback are just two ways from which reputation information can be developed.

In another example, reputation information can be generated according to automatic system interaction between a network entity and other network entities. In a purely system-level example, systems can be programmed or configured to test certain attributes of other systems with which it interacts. For example, a server can be configured to log system interaction data related to a router though which server data can be routed. If, over time, the system log indicates that the router fails routinely, or perhaps drops packets more than what would be considered normal, the reputation information about the router can be developed and used by the server to reroute server packets to a different router that has a lower failure rate and higher percentage of delivered packets. Thus, this information can be used as reputation information related to the router.

Accordingly, the reputation of a website can be an important metric in connection with ranking of search results among other websites, as well as enhancing delivery of meaningful and accurate information to users.

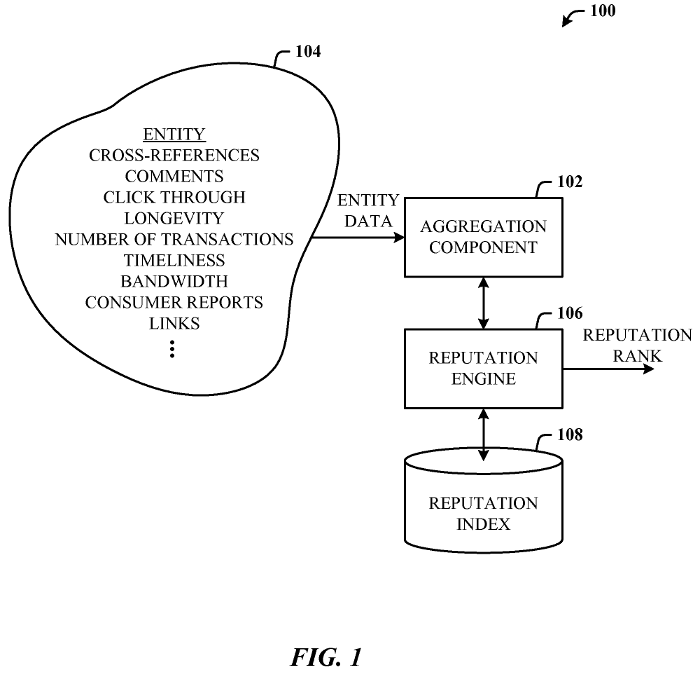

Referring initially to the drawings, FIG. 1 illustrates a computer-implemented system 100 that facilitates network-based interaction utilizing reputation data in accordance with an innovative aspect. The system 100 includes an aggregation component 102 that receives and aggregates data 104 relating to an entity (e.g., a website, network user, hardware, software, . . . ). A reputation engine 106 can access the aggregation data of the aggregation component 102 for analysis and processing to generate reputation data for the entity. A reputation index 108 facilitates storage and indexing of reputation data for access and retrieval.

The entity data that the reputation engine 106 analyzes can include cross-references (e.g., hyperlinks and other referencing techniques), user comments, click-through activity and rates, longevity of the entity or information, number of transactions being processed, timeliness of operation and data delivery, bandwidth capabilities of the entity, user feed-back, reports by consumers or users, links to and from the entity (e.g., a website), and other extrinsic evidence in connection with determining the reputation of entities such as websites, web pages, blogs, etc.

In the context of cross-reference information, reputation data for a first website can be generated based on references (e.g., hyperlinks) to a second or multiple websites. For example, if the first website was originally assessed with reputation data, and provides a link via an advertisement of an associated webpage to a second website whose reputation data was lower, this could lower the overall reputation of the first website. In a most egregious example, if the second website had a reputation of uploading keystroke loggers or viruses to users who accessed it, its reputation could be rated poor, thus, further lowering the reputation of the first website. By validating the reputation data of the second website, and not linking to it, the first website can retain a higher reputation rating and present this to users as a mechanism for encouraging access to the first website.

In another example, reputation information can be developed from user comments. There are forums, blogs, etc., that users access and post information about other entities, such as websites, users that post information on the websites, advertisers, general information sites, and so on. This user feedback information can be analyzed for generating reputation data of the entity. For example, users post information about the reliability and timeliness of a vendor in paying rebates to products purchased from that vendor website. This information can be analyzed to generate reputation information about the subject of the posting.

Click-through rate is another metric by which reputation can be assessed. If the click-through rate is high, it can be inferred that users prefer to access more information of the website in contrast with a website that has a lower click-through rate. Thus, if the first website tends to have a higher click-through rate on content than the second website, generally, the first website can be assigned a higher reputation value.

Timeliness can be another piece of information that can be monitored as part of reputation generation. Timeliness can be related not only to the bandwidth capabilities of the website in handling a large number of users, but also related to how often the site updates its content. If the website tends to update its content infrequently, its reputation can be rated lower than a website that updates its content more frequently. If a website is known to exhibit long connection times, this can be due to its inability to process a large number of transactions. Accordingly, this particular aspect of the reputation data can be rated less that a website that deliver content more quickly and efficiently.

Timeliness can also be related to updating website links. For example, it is known that links from the first website to the second website (or its content) can fail due to the first website not updating or checking its links to ensure they are viable. Accordingly, reputation data for both the first and second website can be affected—the first website reputation can be reduced because it failed to change or update its links to the second website, and the reputation data for the second website can be reduced because it failed to notify the first website that one or more of its links are no longer valid.

Temporal trends in access following world events can provide evidence about the reputation of web sources of timely information, such as breaking news stories. Patterns of temporal popularity of access can be associated with reputation information useful for guiding users to the appropriate sources of information to find information about different classes of events. Such temporal trend information can be used in conjunction with attributes or properties of the sources to construct statistical or logical classifiers of the reputations of sites for providing information in different contexts. Such classifiers can be used to infer the value or reputations of sources of information for providing timely information without observing the temporal patterns, but by leveraging the observations about temporal access patterns in sites used to train the classifiers.

Consumer reports are closely related to comments, however, there can be network entities whose sole function is to analyze and evaluate websites based on any number of factors, including one or more of these mentioned supra. The results can be routinely posted for user viewing, and/or accessed electronically by other websites as a means for assessing the reputation of another network entity, rather than analyzing and processing reputation information and validation as its own separate process.

It is to be understood that although the previous discussion focused on websites as the entity for which reputation information was generated, the entity can be a user. Thus, based on registration information of a user who registers at a website, user reputation information can be generated and utilized to control access to that website or other information. If the user registers with apparently valid information, s/he can be rated higher in reputation (from the perspective of the website) than a user who appears to enter less useful (or bogus) information, simply to gain further access.

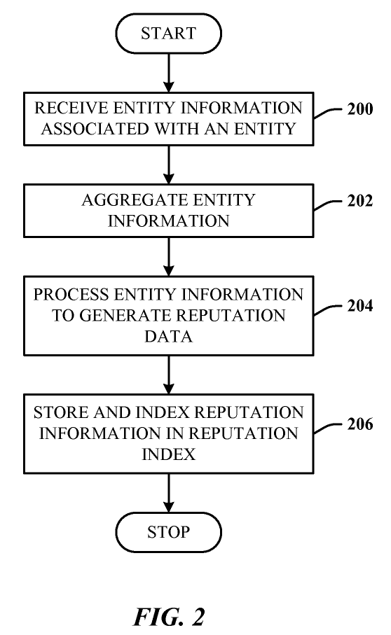

FIG. 2 illustrates a methodology that facilitates network-based interaction utilizing reputation data. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, entity information (or data) associated with an entity is received. This can an IP address of a website or user, URL (uniform resource locator) information of a web page, advertiser information, geographic information of the entity, timeliness information, click-through rate, user comments data, and so on. At 202, the entity information is aggregated for at least analysis and processing. In other words, in one implementation, the received entity data can be processed by clustering according to predetermined criteria. For example, data related to websites can be analyzed and clustered, as well as data received from a user can be clustered with other user data. The type of clustering is at the desire of the user. For example, clustering can be according to the type of received information, or by the entity from which the data was received. At 204, the entity information is processed to generate reputation data. At 206, the reputation data is output, and can also be stored and indexed in the reputation index. In other words, the reputation data can be made available for access by other entities. This facilitates validation of reputation data of one entity as requested by other entities or by the indexing system, for example.

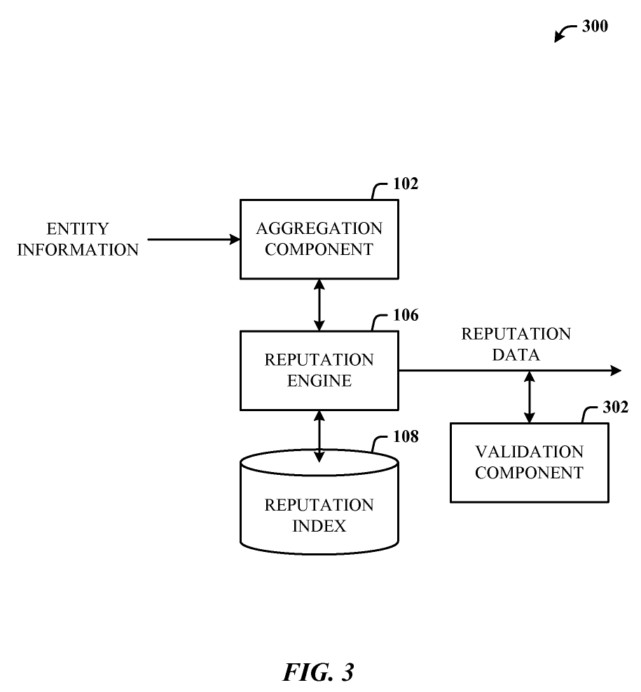

Referring now to FIG. 3, there is illustrated a reputation system 300 that employs a validation component 302 for reputation validation in accordance with another aspect. Validation of the reputation data is to ensure that the actual generated reputation information is what is being processed. In a more robust implementation, validation can include ensuring that the method(s) used to generate the reputation data are sound and accepted, thereby preventing generation of false reputation data. In still another implementation, the validation component ensures that the source of the reputation data is an authenticated source. In accordance with at least these three aspects, the ranked search results and information being conveyed to a user based on the reputation information will have some corresponding degree of acceptability.

The system 300 includes the aggregation component 102 for receiving and aggregating entity data, the reputation engine 106 for accessing the aggregated entity data for analysis and processing to generate reputation data for the entity, and the reputation index 108 for storing and indexing at least the reputation data for access and retrieval. Additionally, the system 300 can include the validation component 302 for validating or authenticating the generated reputation data. Thus, once reputation data has been generated, by whatever means, a system capable of processing the data can validate (or authenticate) the data against another reputation data sources or criteria to ensure that the data is valid or has not been spoofed.

In one application, a first website can set predetermined reputation criteria such that any reputation data obtained that fails to meet or exceed the criteria will result in the related entity being denied association with the first website. As indicated before, this association can be via referencing information such as hyperlinks and/or URL data, for example.

The validation process can be automated as a background process that is transparent to the website administrator. Alternatively, or in combination therewith, validation can be performed manually by a user interface prompting the website administrator to initiate the validation process or portions thereof. In one example, when a webpage having posted links and advertising is generated, the validation process of the validation component 302 can be initiated to validate reputation data for all associated links and referencing information to the reputation index 108. Validations that fail can be presented to the administrator for further processing and notification of the associated website or user.

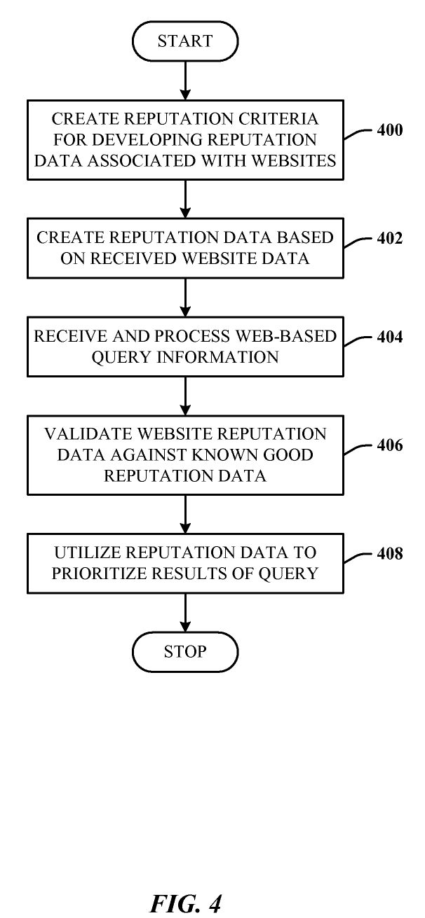

FIG. 4 illustrates a methodology of reputation validation for search processing in accordance with another aspect of the innovation. Given the increasing amounts of data being made available on networks (e.g., the Internet), mechanisms are desired that facilitate focusing search results more to the user's intentions, search goals, etc. Reputation data can be employed to refine the search results. At 400, reputation criteria is defined for developing reputation data associated with one or more websites. At 402, the reputation data is created based on received website data. As indicated supra, the website data can include referenced links, click-through data, and so on. At 404, a query is processed that accesses the one or more websites. At 406, the reputation data associated with the one or more queried websites is accessed and validated. At 408, if properly validated, the reputation data is utilized to prioritize results of the query. Contrariwise, if the validation fails, the search result (or results) can be lowered in rank or even deleted from consideration at all.

Another aspect of reputation processing can be based on a function of vector-based analysis where the number of references to or from a website are determined and considered in connection with rating the reputation of the site.

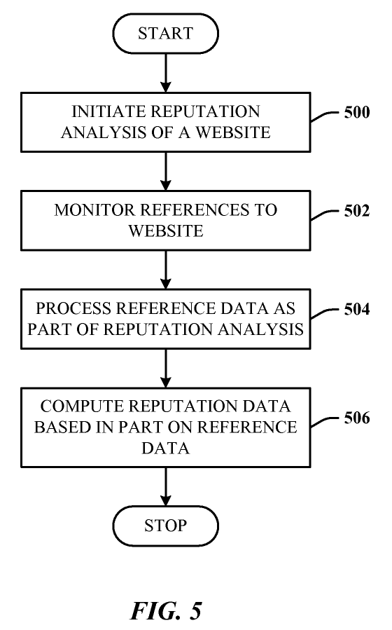

FIG. 5 illustrates a methodology of factoring in reference data of a website as part of the generation of reputation data. At 500, reputation analysis of a website is initiated. At 502, the system monitors the reference information. This can include monitoring site logs of all incoming and/or outgoing links or other similar references associated with the website, for example. At 504, the reference data is processed as part of the reputation analysis. At 506, the reputation data is computed based in part on the reference data, and then output or stored for access.

In one example of direct determination, logs of user access via links or other website references can be accessed and analyzed as part of the reputation data generation and ranking process. In another example, analysis of source information of a website webpage for referencing information can be provided as part of the reputation data generation process. In yet another implementation, the type and/or format of content presentation of a site can be analyzed. For example, if the type of content generally presented by a second website is that which a first website recognizes as less than desirable, the reputation data for the second website can be downgraded relative to the expected associations desired by the first website. Further, if the second website is associated with referencing information to a third website that is considered (according to the first website criteria) to be less than desirable, the reputation data of the second website can be downgraded by its association with a website that does not meet the criteria of the first website. Accordingly, the number of vectors to the second website, and from that second website to other websites, and so on, can be made part of reputation analysis.

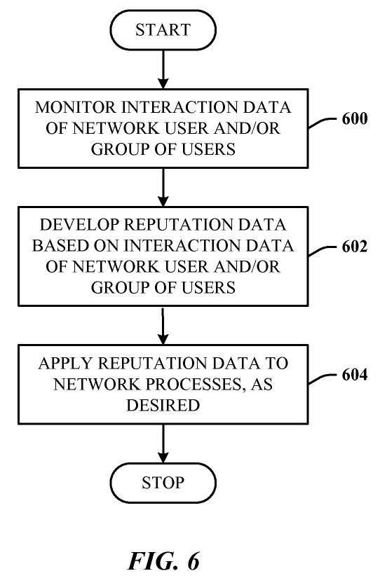

Another aspect considers reputation processing for individuals and/or groups of individuals in relation to on-line social networks, dating, referral services, restaurants, vendors, etc. FIG. 6 illustrates a methodology of reputation analysis based on users in accordance with the disclosed innovation. At 600, interaction data of a network user and/or group of network users is monitored. At 602, reputation data is developed based on the interaction data. At 604, the generated reputation data is then applied to network processes, as desired. For example, the network processes can be those related to grouping or clustering users according to the reputation data, thereby providing groups to which access can be managed. Poor reputation data associated with a user can facilitate limiting user access to groups, or even prohibiting access at all. On the other hand, good reputation data can be utilized to allow the user access to some or all groups.

It is further to be understood that an individual can have multiple representations of reputation data. For example, user reputation may be better at one website than at another. Accordingly, reputation data can be associated with context and content, and other properties or attributes. In other words, a user may interact differently based on the content being perceived. Similarly, the user can interact differently based on the user context (e.g., a hardware context based on using a cell phone versus a laptop computer).

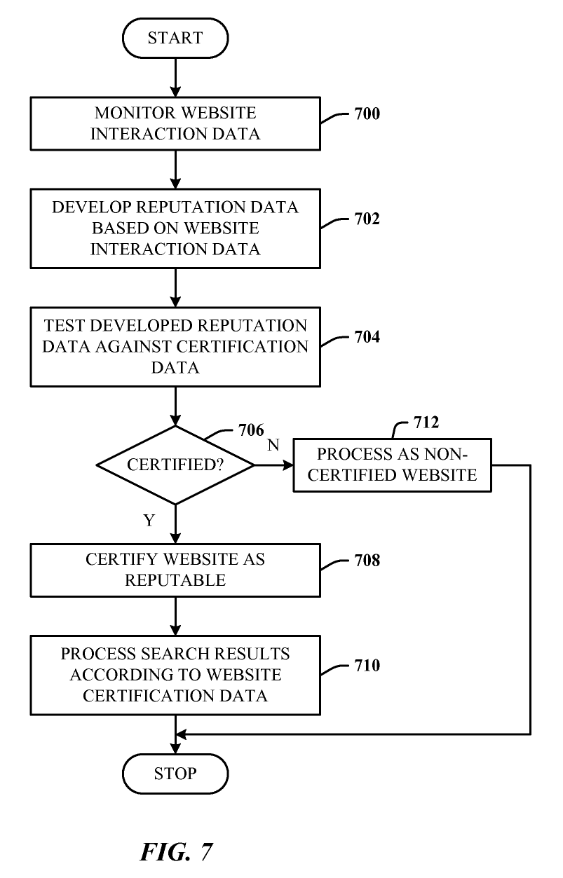

In an alternative implementation, the disclosed architecture functions as an authenticity enabler that 3^{rd} parties can employ to provide a user with a measure of quality about their website meeting a pre-determined standard of quality. FIG. 7 illustrates a methodology of reputation analysis and generation for a purpose of website certification in accordance with another aspect. At 700, the website can be monitored for interaction data. This interaction data can include user interaction as well as system-to-system interaction and processing capabilities. For example, if the website processing power is inadequate, it may not be capable of processing the number of hits which can be expected to occur as an Internet-based system. Accordingly, the reputation data can reflect this as a negative attribute.

In another example, if the site is routinely visited and allowed access by users whose reputation data indicates a lower quality of interaction, this can be factored into the certification process of the website. The quality of interaction need not be limited to users who simply click-through to other sites, for example, but can include other aspects, such as duration of visit, is the address of the user associated with known dubious origins or service provider networks, was a purchase made, etc.

At 702, reputation data is developed based on the website interaction data. At 704, the developed reputation data is tested against certification data. The certified data can include a single threshold which must be passed in order to meet the certification standard of quality. Alternatively, certification can include multiple different levels that can be used as a label on a home page, such as, “This is a Certification B website, as certified by . . . ” Accordingly, certifications can change as associated reputation data changes. At 706, the system checks to see if the site reputation data indicates a passing certification. If so, at 708, the website is certified as meeting a standard of quality. At 710, search results can then be managed according to websites (and associated web pages), based on whole or in part on the reputation data and/or certification information.

At 706, if the website does not meet the certification criteria, the site and any related data can be processed as a non-certified site, as indicated at 712. Similarly, it is within contemplation that any users associated with that site can have reputation data that factors in the user association with that site, as determined, for example, by the number of user accesses, domain information, etc.

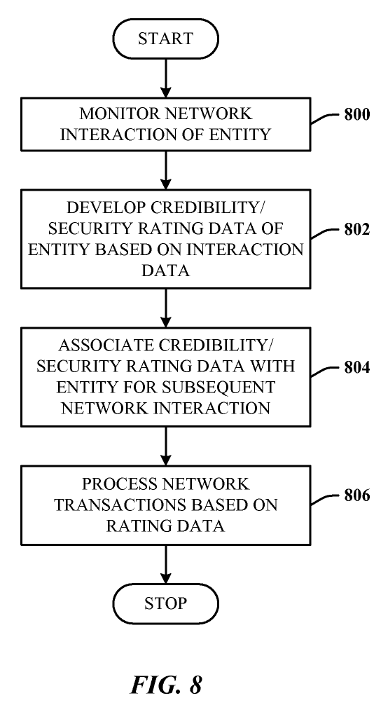

A credibility/security rating for individuals and/or websites can also be generated that facilitates individuals with high credibility undergoing lesser scrutiny per Internet-based transaction in view of his/her credentials than a person having lower credibility. FIG. 8 illustrates a flow diagram of a methodology of developing and utilizing credibility/security rating data in accordance with an innovative aspect. At 800, network interaction is monitored. This can include user logins (and failed logins), users surfing through the website, and so on. At 802, credibility and/or security rating data of an entity (e.g., a user and a website) are developed based on the interaction data. At 804, once developed, the credibility/security rating data is associated with the user and accessed on subsequent interactions. At 806, network transactions by the entity include accessing, analyzing and processing of the credibility/security rating data, which can affect how the transaction is handled. For example, if the rating data is below a minimum standard, the transaction can be processed differently, or even prohibited from being processed at all.

Advertising and economic models can also be based in part on reputation data and reputation data rankings generated. Generally, an economic model is a simplified framework that represents economic processes by a set of variables and variable relationships (e.g., logical and quantitative). In association with reputation data, qualitative analysis of the model can be performed to provide some level of quality associated therewith. For example, if the model information (advertising and/or economic) can be further analyzed and processed in view of the reputation data, this can provide an additional metric for determining viability of the model.

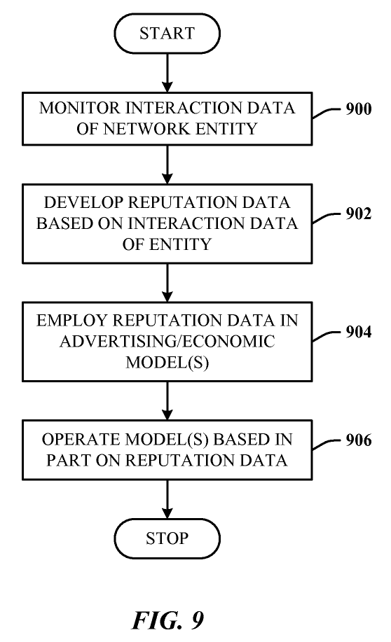

FIG. 9 illustrates a flow diagram of a methodology for employing reputation data in advertising and/or economic models. At 900, network interaction is monitored. As before, this can include user logins (and failed login attempts), users surfing through the website, click-through activity, making a purchase, and so on. At 902, reputation data of an entity (e.g., a user and a website) is developed based on the interaction data. At 904, the reputation data is employed in an advertising model and/or an economic model. For example, reputation data associated with an advertiser can be utilized to rank web searches. Reputation data that exceeds a known parameter can be ranked higher than data associated with a lower value. In another example, the reputation data can be generated based on the advertisement content and not specifically with the advertiser.

With respect to economic models, reputation data can be employed to affect computations related to any data of the model. Such a model abstracts from complex human behavior to shed some insight into a particular aspect of that behavior. The expression of a model can be in the form of words, diagrams, and/or mathematical equations. Accordingly, at 906, the model(s) are operated based on the reputation data.

The reputation data can be utilized in advertising and economic models as a mechanism for provided bonuses for referrals to other entities, such as users, or websites, for example. In the context of hardware and software, the fact that one device (or software application) is referred to over another in a network of such entities can be a mechanism for rewarding the entity vendor or administrator for the referral.

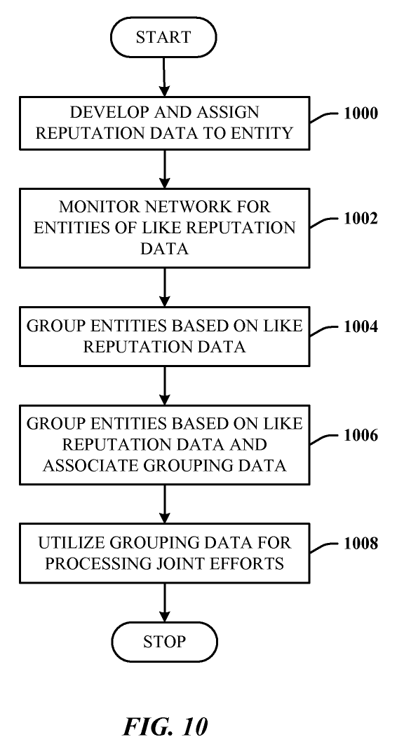

A peer-to-peer (P2P) implementation of reputation data processing can provide for clustering and/or introducing individuals of like reputation and quality of services for leveraging of joint efforts with respect to a variety of efforts (e.g., group projects, file sharing, coordinated searching/research, and news reporting). FIG. 10 illustrates a methodology of peer network processing of reputation information in accordance with an aspect of the innovation. At 1000, reputation data is developed and assigned to (or associated with) an entity (e.g., a user, website, application, . . . ). At 1002, the network is monitored for entities of like reputation data. This can be performed in a number of different ways. For example, the entity can be a user accessing the network via a device (e.g., wireless or wired) that is associated with a MAC (media access control) address which uniquely identifies the associated hardware, and which MAC data can further be associated with the reputation data. Thus, when the hardware is detected on the network, the associated reputation data can be accessed and processed for similarity with reputation data of other network entities. The reputation data can be generated and stored locally on the device for access and processing.

At 1004, the entities on the network are grouped according to like reputation data. This can be accomplished via a software program on one or more of the P2P devices that receive reputation data from all network entities and computes similarity data in order to perform the grouping operation. The groupings or clustering can be recomputed after each entity enters the P2P network. Thus, it can be possible that an existing single group will be dissolved and reorganized (e.g., into two groups) according to the presence of a new network entity and how its reputation data will effect change in the balance of groupings. At 1006, grouping data that identifies entity groupings can also be associated with the reputation data, for the existing in situ network relationships. This mapping can be stored on one or more of the network entities in case one of the peer devices goes offline, and re-connects to the peer network. At 1008, the grouping data and/or the reputation data can be used for processing joint efforts of the group. For example, in a social P2P network, ad hoc establishment of a group based on reputation data, for example, no matter how brief in time, can form a barrier to uninvited users. In another example, the grouping data and/or reputation data can be utilized to not only form groups of similar users, but to restrict access to files created by the group.

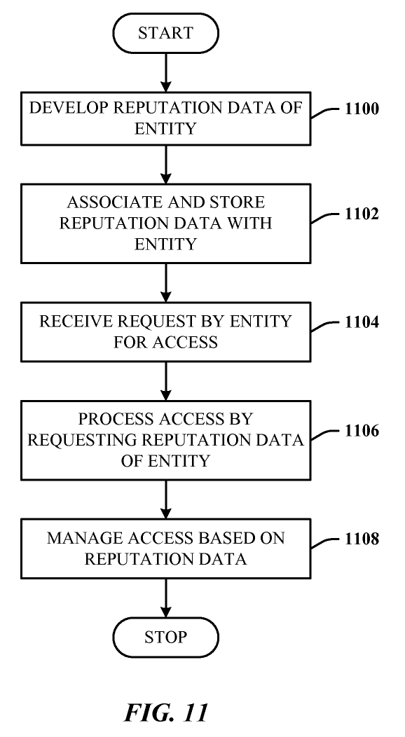

FIG. 11 illustrates a flow diagram of a methodology of managing access based on reputation data. Controlled access (e.g., similar to a hardware or software key) can be facilitated by reputation data. At 1100, reputation data for an entity is created. At 1102, the reputation data is associated and stored with entity information. At 1104, access to a device, software, or data, for example, is requested. In one example, this is access to a computing system via a hardware key (e.g., a dongle) and/or software (e.g., a program or application) via a software key. At 1106, access is processed using the reputation data of the entity.

The entity can be a user that seeks login access to a computing device or cellular device, and/or to a software application (e.g., an e-mail program). The entity can be a device seeking access to a network via another device and/or software. Accordingly, the device can have reputation data developed and associated with it, and which is considered as part of access processing for the access it seeks. Device reputation data can include device reliability information, such as how many times has the device failed and what user typically uses the device, for example. The entity can be software that has its own reputation data developed and based on, for example, its reliability (e.g., crash data, uptime, . . . ) and a user that typically interacts with the software.

Accordingly, at 1108, access can be controlled in many different ways by utilizing the reputation data. Additionally, the reputation data can be employed for authenticating user identity, such as in a cell phone prior to allowing operation of the cell phone. The reputation data can also be employed in a smart stub that interfaces to a port that facilitates operation of the device only when the stub is present, such as traditionally provided by a hardware key or dongle. This can be conveniently utilized with a cell phone, and may further require a properly input PIN for full access to cell phone operation.

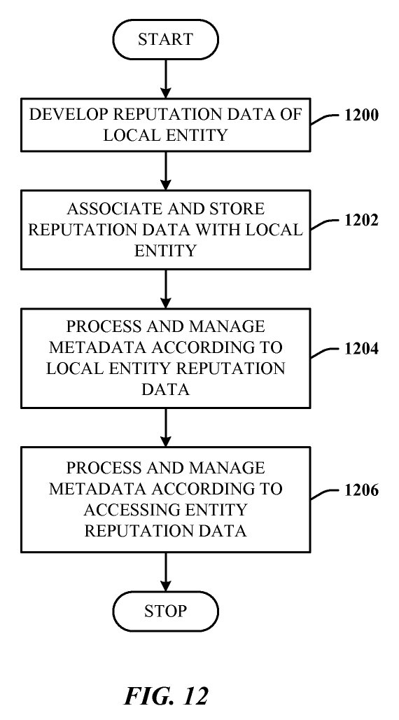

FIG. 12 illustrates a methodology of processing metadata based on reputation information. At 1200, reputation data is generated for a local entity (e.g., user, device, and application). At 1202, the reputation data is stored in association with the local entity. At 1204, metadata associated with files is processed and stored based in part on the reputation data. In one example, the metadata can be modified to a state other than a normal state based on the reputation data. More specifically, if the reputation data indicates a lower reputation value, the associated metadata of a file, for example, can indicate that the file will be aged out (or deleted) more quickly than a file associated with a higher level of reputation data. This is indicated at 1206 where the metadata is processed and managed according to the entity reputation data.

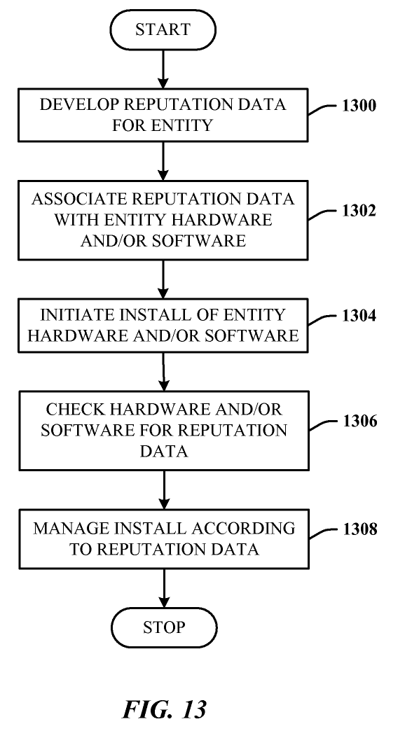

FIG. 13 illustrates a flow diagram that represents a methodology of managing application installation and operation based in part on reputation data in accordance with a novel aspect. At 1300, reputation data is developed for an entity (e.g., hardware and software). At 1302, the reputation data is associated with the entity hardware and software. This can be stored in firmware and/or non-volatile memory (e.g., flash memory cards or chips) that is updateable for changes in the reputation data. In this example, the reputation data can be based on vendor characteristics such as known reliability aspects, quality of workmanship, and so on. At 1304, an installation process is initiated of the associated hardware and/or software. At 1306, during the installation process, the reputation data is accessed from the hardware and/or software. At 1308, the install is managed according to the reputation data.

In another example, installed hardware and/or software can include reputation data from the vendor, or after installation, become associated with reputation data which is thereafter utilized to prevent installation of unwanted software, for example. A common annoyance that exists today is the faking of toolbars and toolbar clicks that route user programs to unwanted websites and/or cause unwanted file downloads. Moreover, the reputation data can be employed to function as digital rights management (DRM) data for software to provide another means for preventing unwanted and undesirable software downloads and installs. Additionally, the lack of reputation data with software can further be employed to prevent unqualified search results from being ranked for selection when the references would lead to undesired websites and/or documents. Thus, only software and hardware with suitable reputation data will be allowed to operate at some level or no level at all.

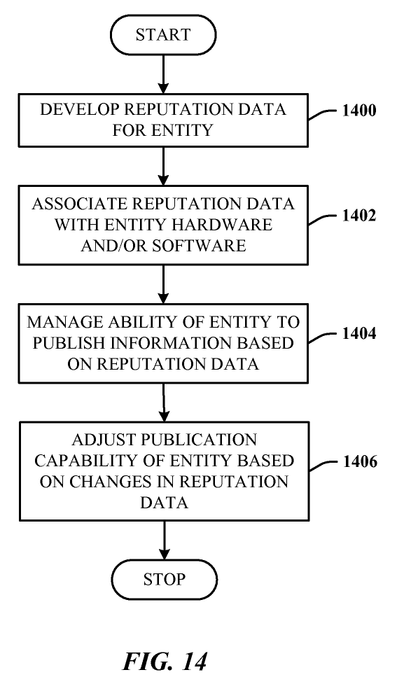

FIG. 14 illustrates a flow diagram that represents a methodology of managing document publication based in part on reputation data. At 1400, the reputation data is developed for an entity (e.g., a company). At 1402, the reputation data is associated with entity hardware and/or software. At 1404, the ability of the company to publish information is affected by the reputation data. For example, there can be a central certification entity that issues levels of reputation data based on qualifications of the company. Accordingly, the ability of the company to output or publish web pages or other document types can be managed by the level or total absence of reputation data, as indicated at 1406.

Along the same lines, the reputation data can be employed as a digital signature for documents, as validation data for similar purposes, and to authenticate code, for example.

Reputation data can also be employed for application such as crawlers that automatically seek and retrieve information got storage at locations that can be routinely and more conveniently and efficiently accessed by other entities. For example, local repositories of data and other information can be updated on regular intervals from Internet-based sources, and local users and systems can take advantage of this local availability for access rather than committing power and bandwidth to accessing the same information from the Internet. Accordingly, reputation data can be utilized as a means for receiving only qualified data and information that includes suitable accompanying reputation data, and/or as a means for at the local repository for filtering data and information that does not include suitable reputation data.

Thus, web page document preparation programs and publishing tools can be designed to, for example, tag documents with reputation data as a means for automatic authentication and validation when being accessed by other entities (e.g., users, hardware and software).

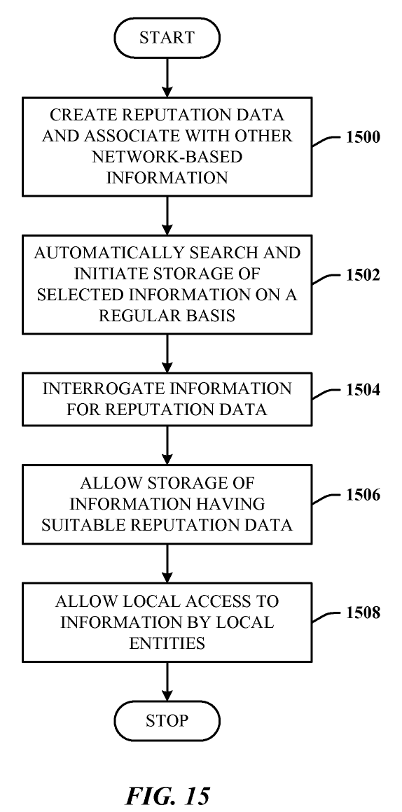

FIG. 15 illustrates a methodology of managing central data and information repositories by utilizing reputation data. At 1500, reputation data associated with network-based data, documents, etc., is created and associated therewith. At 1502, one or more systems automatically search and initiate storage of the selected information (e.g., on a regular basis). At 1504, as the information is being retrieved it can be interrogated for the reputation data. At 1506, storage of information having suitable reputation data is allowed. At 1508, local access to the stored data is then allowed by one or more local entities.

The reputation data can also be employed in cooperation with communications related to, for example, instant messaging software. Thus, only messages having suitable reputation data associated therewith will be processed for communications. Similarly, devices (e.g., cell phones, messaging-centric devices, . . . ) designated for receiving the reputation can be managed to limit unwanted messages.

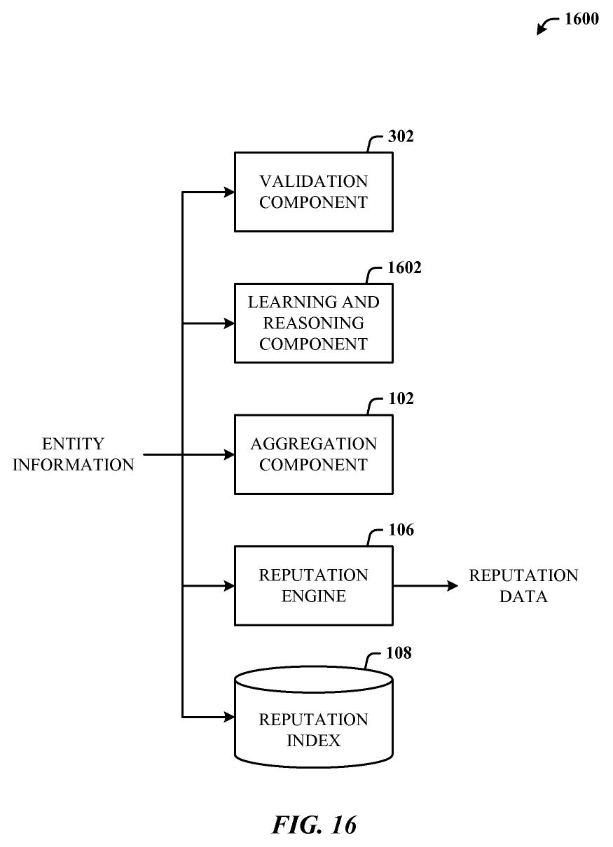

FIG. 16 illustrates a system 1600 that employs a machine learning and reasoning (MLR) component 1602 which facilitates automating one or more features in accordance with the subject innovation. In connection with selection, for example, various MLR-based schemes can be employed for carrying out various aspects thereof. For example, a process for determining when to update and/or apply reputation data can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier can be trained based on actual reputation metrics such as hits, the number of hits over time, and so on, and then such a classifier can be used to assign measures of reputation directly to websites without requiring the observation of hits.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject architecture can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one example, the component 1602 can facilitate when to update reputation data associated with an entity. This can be determined by learning and reasoning about the entity activity on a network, or by hardware or software activity, for example.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The system 1600 can also employ the aggregation component 102 for receiving entity information, the reputation engine 106 for generating the reputation data, the reputation index 108 for storage and indexing of the reputation data, and the validation component 302 for validation and/or authentication of the reputation data against other reputation data.

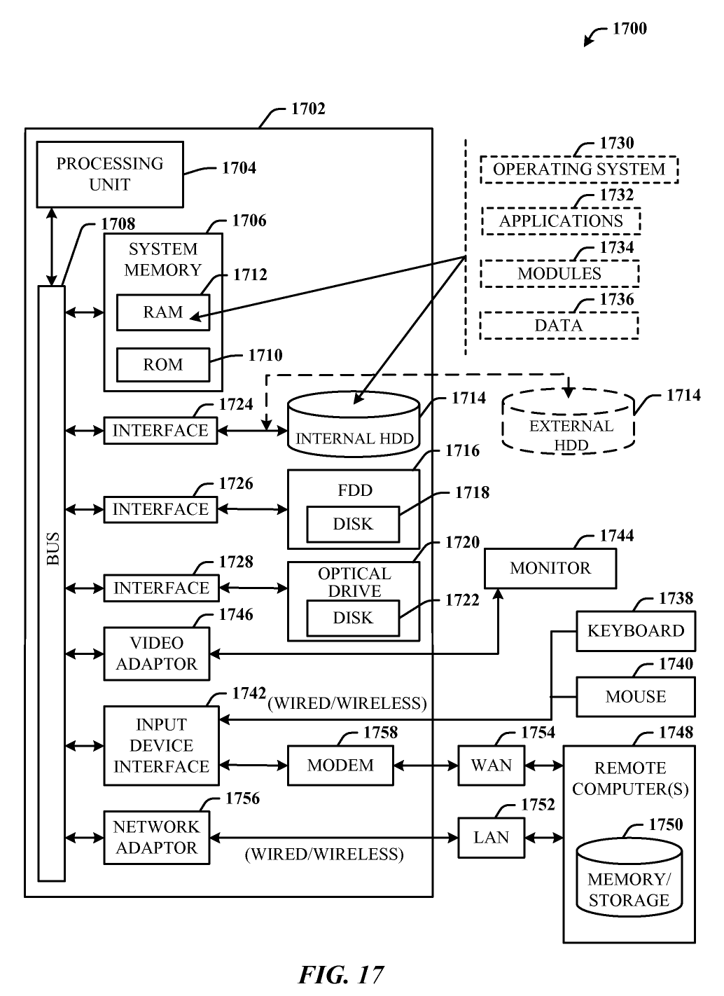

Referring now to FIG. 17, there is illustrated a block diagram of a computer operable to facilitate development, analysis and processing of reputation data, and execution of other aspects of the disclosed architecture. In order to provide additional context for various aspects thereof, FIG. 17 and the following discussion are intended to provide a brief, general description of a suitable computing environment 1700 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 17, the exemplary environment 1700 for implementing various aspects includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for caching data.

The computer 1702 further includes an internal hard disk drive (HDD) 1714 (e.g., EIDE, SATA), which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. It is to be appreciated that the innovation can be implemented with various commercially available operating systems or combinations of operating systems.

A user can enter commands and information into the computer 1702 through one or more wired/wireless input devices, for example, a keyboard 1738 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE 1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the local network 1752 through a wired and/or wireless communication network interface or adapter 1756. The adaptor 1756 may facilitate wired or wireless communication to the LAN 1752, which may also include a wireless access point disposed thereon for communicating with the wireless adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

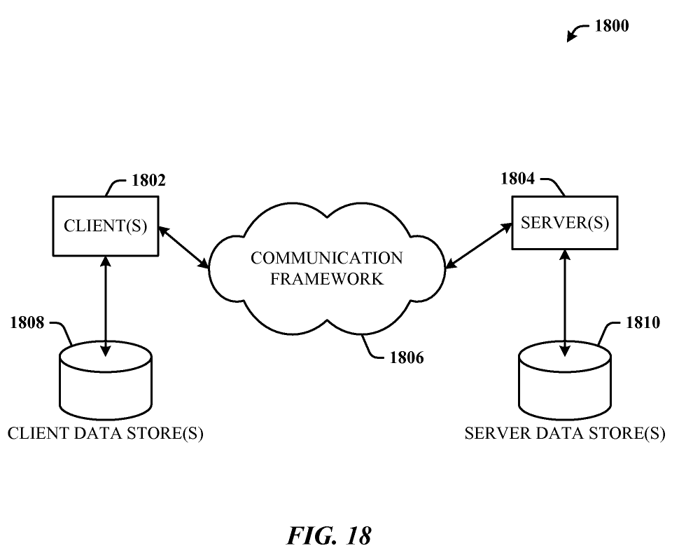

Referring now to FIG. 18, there is illustrated a schematic block diagram of an exemplary computing environment 1800 operable for processing reputation data in accordance with another aspect. The system 1800 includes one or more client(s) 1802. The client(s) 1802 can be hardware and/or software (e.g., threads, processes, computing devices). The client(s) 1802 can house cookie(s) and/or associated contextual information by employing the subject innovation, for example.

The system 1800 also includes one or more server(s) 1804. The server(s) 1804 can also be hardware and/or software (e.g., threads, processes, computing devices). The servers 1804 can house threads to perform transformations by employing the invention, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates network-based interaction, comprising:
an aggregation component that receives and aggregates information related to click-through rate of a website; and
a reputation engine that employs the aggregated information to generate reputation data based on the click-through rate.

2. The system of claim 1, further comprising a reputation index that indexes the reputation data for storage and retrieval.

3. The system of claim 1, further comprising a validation component that authenticates the reputation data associated with the website.

4. The system of claim 1, wherein aggregation component aggregates information related to user interaction information associated with at least one of data, hardware and software.

5. The system of claim 1, wherein the aggregation component aggregates information related to at least one of data, hardware, and software of the website, and the reputation data generated by the reputation engine is related to reputation of at least one of data, hardware, and software of the website.

6. The system of claim 1, wherein the reputation data is utilized to rank results of a search.

7. The system of claim 1, wherein the reputation engine generates the reputation data as part of or in association with an advertising model to provide qualitative information related thereto.

8. The system of claim 1, wherein the reputation engine generates the reputation data as part of or in association with an economic model to provide qualitative information related thereto.

9. The system of claim 1, further comprising a validation component that validates the reputation data in relation to at least one of another website, a web page, a blog, and a social network.

10. The system of claim 1, wherein the aggregation component aggregates additional website information related to at least one of a cross-reference, a comment, longevity of the website, number of website transactions, timeliness of the website information, bandwidth, consumer reports about the website and, links to and from the website.

11. The system of claim 1, further comprising a machine learning and reasoning component that employs a probabilistic and/or statistical-based methods to build classifiers that output the reputation directly independent of how the reputation is used subsequently.

12. A computer-implemented method that facilitates network-based interaction, comprising:
receiving website information related to a website;
aggregating the information for analysis and processing;
creating reputation data from the website information;
outputting the reputation data for use by other network systems; and
validating the reputation data in response to a search.

13. The method of claim 12, further comprising processing the reputation data to determine which network information to pull from the network systems and store locally on the website for local access.

14. The method of claim 12, further comprising authenticating reputation data received from one of the other network systems.

15. The method of claim 12, further comprising controlling access to hardware based upon the reputation data.

16. The method of claim 12, further comprising controlling access to a software application based upon the reputation data.

17. The method of claim 12, further comprising controlling access to a group of network users based on the reputation data.

18. The method of claim 12, further comprising grouping network website based upon the reputation data provided by one or more of the network systems.

19. The method of claim 12, further comprising managing publication of documents of the website based on the reputation data.

20. A computer-executable system, comprising:
computer-implemented means for receiving website information related to a website;
computer-implemented means for aggregating the website information for analysis and processing;
computer-implemented means for creating reputation data from the website information based in part on interaction with the website, the reputation data created at least one of manually and automatically;
computer-implemented means for providing access to the reputation data by other network systems; and
computer-implemented means for ranking search results based on the reputation data.
